(19) United States
(12) Patent Application Publication
(10) Pub. No.: US 2020/0136467 A1
(43) Pub. Date: Apr. 30, 2020

(54) SYSTEM AND METHOD FOR HARVESTING ENERGY

(71) Applicant: UNIVERSITY OF UTAH RESEARCH FOUNDATION, Salt Lake City, CA (US)

(72) Inventors: Hanseup Kim, Salt Lake City, UT (US); Mahbubur Rahman, Salt Lake City, UT (US); Jonathan Neil Hart, Salt Lake City, UT (US)

(21) Appl. No.: 16/664,436

(22) Filed: Oct. 25, 2019

Related U.S. Application Data
(60) Provisional application No. 62/753,568, filed on Oct. 31, 2018.

(51) Int. Cl. H02K 7/18; F15B 11/08; A43B 3/00

(52) U.S. Cl. CPC H02K 7/1884; A43B 3/0015; F15B 11/08

(57) ABSTRACT

An energy harvesting system including a channel, a first coil having a clockwise rotation around the channel, a second coil having a counter clockwise rotation around the channel, and magnetic train. The magnetic train is configured to move through the channel, the magnetic train including a plurality of oppositely-alternating magnets.

### RELATED APPLICATIONS

This application claims priority to U.S. Provisional Application No. 62/753,568, filed on Oct. 31, 2018, which is hereby incorporated by reference.

### FIELD

Embodiments relate to harvesting energy, more particularly, electrical energy via a spacer-less magnet configuration.

### SUMMARY

Energy harvesting systems, such as but not limited to U.S. Pat. No. 9,887,610, which is hereby incorporated by reference, may be configured to convert mechanical energy into electrical energy.

One embodiment of the present application provides an energy harvesting system including a channel, a first coil having a clockwise rotation around the channel, a second coil having a counter clockwise rotation around the channel, and magnetic train. The magnetic train is configured to move through the channel, the magnetic train including a plurality of oppositely-alternating magnets.

Another embodiment discloses a method for generating energy. The method including applying a force, via a piston, to a fluid to cause movement within a channel. The channel has a first coil having a clockwise rotation around the channel and a second coil having a counter clockwise rotation around the channel. The method further including causing movement, via the fluid, of a magnet train situated within the channel. The magnet train includes a plurality of oppositely-alternating magnets. The method further includes generating, via the magnet train, a voltage in at least one selected from a group consisting of the first coil and the second coil.

Other aspects of the application will become apparent by consideration of the detailed description and accompanying drawings.

### BRIEF DESCRIPTION OF THE DRAWINGS

FIGS. 1A & 1B illustrate a side view of an energy harvesting system according to some embodiments.

FIG. 2 illustrates a block diagram of a magnetic train of the energy harvesting system of FIGS. 1A & 1B according to some embodiments.

FIG. 3 includes graphs illustrating polarity and flux density of a magnetic train of the energy harvesting system of FIGS. 1A & 1B according to some embodiments.

FIGS. 4A-4C are perspective views of the system of FIGS. 1A & 1B according to various embodiments.

FIG. 5 is a perspective view of the system of FIGS. 1A & 1B according to an embodiment.

FIGS. 6A-6C illustrate the system of FIGS. 1A & 1B incorporated into an insole of a shoe according to various embodiments.

FIG. 7 is a block diagram of the system of the energy harvesting system of FIGS. 1A & 1B according to some embodiments.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

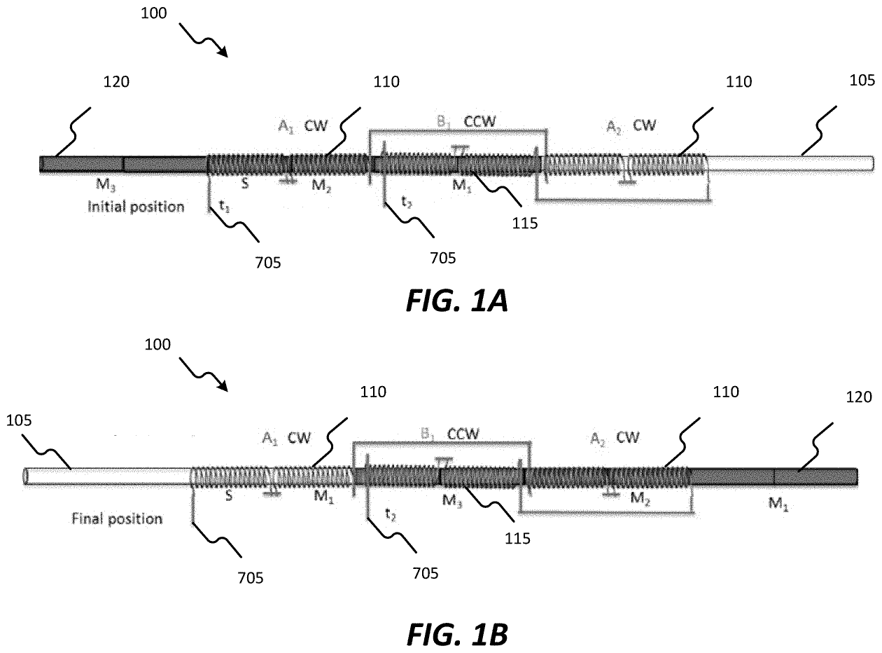

FIGS. 1A and 1B illustrate an energy harvesting system 100 according to some embodiments. In some embodiments, the system 100 is a microfluidic based electromagnetic energy harvester. In the illustrated embodiment, the energy harvesting system 100 includes a channel 105. A first coil 110 and a second coil 115 may be wrapped around the channel 105. The first coil 110 and the second coil 115 include N number of turns. In some embodiments, the first coil 110 and the second coil 115 include the same N number of turns, while in other embodiments, the first coil 110 and the second coil 115 include different N number of turns.

In some embodiments, the first coil 110 is wrapped in a clockwise manner, while the second coil 115 is wrapped in a counter-clockwise manner. In other embodiments, the first coil 110 may be wrapped in a counter-clockwise manner, while the second coil is wrapped in a clockwise manner. As illustrated, in some embodiments, the system 100 includes more than one first coil 110 and/or more than one second coil 115.

A magnetic train 120 may be disposed within the channel 105. The magnetic train 120 may be configured to move through the channel 105 such that the magnetic train 120 moves through the first coil 110 and the second coil 115.

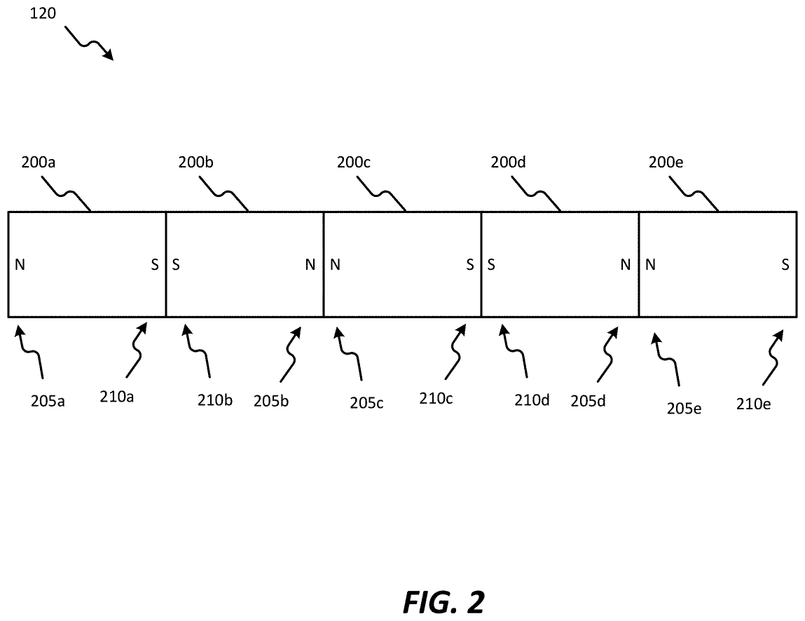

FIG. 2 illustrates the magnetic train 120 according to some embodiments. The magnetic train includes a plurality of magnets 200 (for example, magnets 200a, 200b, 200c, 200d, 200e). In some embodiments, the magnets 200 are permanent magnets.

In the illustrated embodiments, the magnets 200 are positioned in an oppositely-alternating manner. For example, magnet 200a may be in a first position (a NS position) having a first north polarity 205a and a first south polarity 210a, while magnet 200b may be in a second position (a SN position) having a second north polarity 205b and a second south polarity 210b. As illustrated, when in an oppositely-alternating manner, the first south polarity 210a of the first magnet 200a is proximate the second south polarity 210b of the second magnet 200b. Although illustrated as including five magnets 200, in other embodiments, the magnetic train 120 may include more or less magnets.

In some embodiments, the magnetic train 120 is a spacer-less magnetic train. For example, the plurality of magnets 200 may be directly coupled to each other, such that there is no spacers (for example, non-magnetic components) placed between the plurality of magnets 200.

In operation, the magnetic train 120 travels through the channel 105, and thus the interiors of the first coil 110 and the second coil 115. As the magnetic train 120 travels through the first and second coils 110, 115, a voltage e_{coil} is induced in the coils 110, 115. As illustrated in FIG. 1A, the magnetic train 120 has an initial position. The magnetic train 120 moves through the coils 110, 115 to a second, or final, position as illustrated in FIG. 1B. In an alternative embodiment, a different N number of turns between the first coil 110 and the second coil 115 results in a voltage difference between the two coils that increases as the difference between the N number of turns increases.

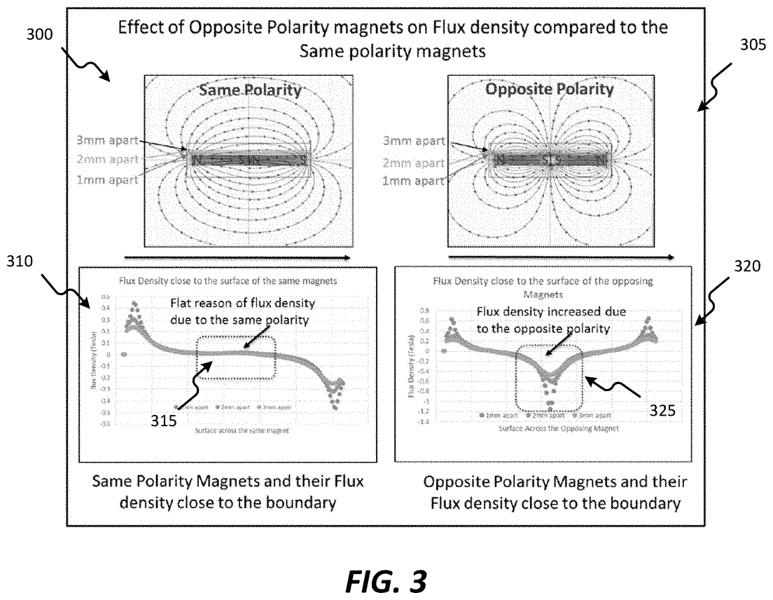

FIG. 3 illustrates a magnetic field 300 of a magnetic train including a plurality of magnets having same polarity compared with a magnetic field 305 of the magnetic train 120 according to some embodiments. As illustrated, the magnetic field 300 results in a flux density 310 having a flat portion 315, while the magnetic field 305 results in a flux density 320 having a flux density increase 325. The magnetic field 305, and resulting flux density 320, may provide a voltage e_{coil} that is approximately 1.8 to approximately 1.9 times greater than a voltage provided by the magnetic field 300. Such an increase in voltage e_{coil} may reduce in a power generation increase of approximately 3.4 to approximately 3.7 times greater.

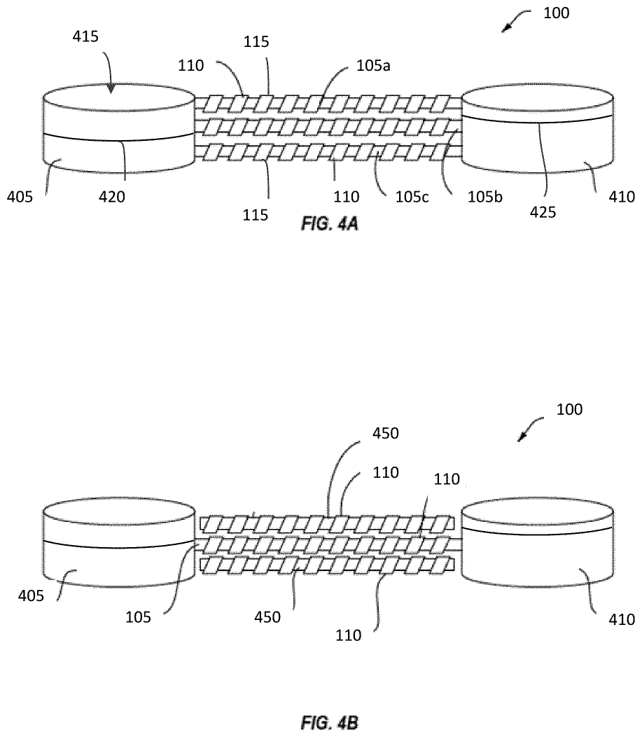

FIGS. 4A and 4B illustrate perspective views of the system 100 according to some embodiments. As illustrated in FIG. 4A, in some embodiments, the system 100 may include a plurality of channels 105a, 105b, and 105c surrounds by coils 110, 115. Additionally, such an embodiment may include one or more chambers (for example, a first chamber 405 and a second chamber 410).

The system 100 may include a fluid 415. Although illustrated as being within the first chamber 405, the fluid 415 may be within the first chamber 405, the second chamber 410, and/or a channel 105 (including, but not limited to, channels 105a, 105b, and/or 105c of FIG. 4A). In some embodiments, the one or more channels 105, the first chamber 405, and the second chamber 410 form a single container having the same pressure of the fluid 415 throughout (for example, when the fluid 415 is an incompressible fluid). In other embodiments, the pressure may vary throughout the one or more channels 105, the first chamber 405, and the second chamber 410 (for example, when the fluid 415 is a compressible fluid).

The fluid 415 may promote movement of the magnetic train 120 through the one or more channels 105, the first chamber 405, and/or the second chamber 410. For example, the fluid 415 may provide separation between the magnetic train 120 and an interior wall of the one or more channels 105, the first chamber 405, and/or the second chamber 410. Additionally, the fluid 415 may reduce friction between the magnetic train 120 and an interior wall of the one or more channels 105, the first chamber 405, and/or the second chamber 410. Furthermore, the fluid 415 may transmit mechanical energy, received by the system 100, to movement of the magnetic train 120 through the one or more channels 105, the first chamber 405, and/or the second chamber 410. Such transmission of mechanical energy may occur through direct pressure applied by the fluid 415 and/or the friction or viscosity of the fluid 415 as it passes the magnetic train 120.

In some embodiments, the one or more channels 105 may having an internal diameter of approximately 1 mm to approximately 2 mm; approximately 1.5 mm to approximately 3 mm; approximately 2 mm to approximately 5 mm; and/or approximately 4 mm to approximately 10 mm. The magnetic train 120 may have a comparable diameter to those discussed above such that the magnetic train 120 is allowed to move within the one or more channels 105.

In some embodiments, the first chamber 405 includes a first piston 420, while the second chamber 410 includes a second piston 425. The first and second pistons 420, 425 may be configured to move within the respective first and second chambers 405, 410. In some embodiments, the first and second pistons 420, 425 may be membranes. For example, the first and second pistons 420, 425 may be flexible membranes, which can stretch and deform and then return to their respective undeformed shapes and sizes. In some embodiments, the chambers 405, 410 are formed of a flexible material. In such an embodiment, the pistons 420, 425 may remain stationary with respect to the walls of the respective chambers 405, 410, and as the pistons 420, 425 move, the respective chambers 405, 410 can deform, in order to pressurize the fluid 415.

A first force F₁ may be applied to the fluid 415 (for example, via movement of piston 420 and/or movement of chamber 405). The first force F₁ may result in the fluid 415 being pressurized and forced to flow toward the second chamber 410 (via one or more channels 105). As discussed above, as the fluid 415 flows through the one or more channels 105, the magnetic train 120 moves through the channels 105, and thus the coils 110, 115, resulting in voltage e_{coil} being induced in the coils 110, 115.

As the fluid 415 enters the second chamber 410, a counteractive second force F₂ may be applied to the fluid 415 (for example, via movement of piston 425 and/or movement of the chamber 410). The second force F₂ may result in the fluid 415 being pressurized and forced to flow back to the first chamber 405 (via one or more channels 105). Once again, as the fluid 415 flows through the one or more channels 105, the magnetic train 120 moves through the channels 105, and thus the coils 110, 115, resulting in voltage e_{coil} being induced in the coils 110, 115. Movement of the fluid 415 may continuously alternate between the first chamber 405 and the second chamber 410, thus continuously moving the magnetic train 120 through the channels 105, and thus the coils 110, 115.

FIG. 4B illustrates the system 100 according to some embodiments. In such an embodiment, the system 100 may include one or more parasitic channels 450. The parasitic channels 450 may be unconnected from the chamber 405, 410. In some embodiments, the parasitic channels 450 may be substantially similar to channels 105 (for example, surrounded by coils 110, 115, include a magnetic train 120, and have fluid 415 contained within). In some embodiments, movement of a magnetic train 120 within a parasitic channel 450 may be caused by a magnetic force from a magnetic train 120 travelling through one or more channels 105.

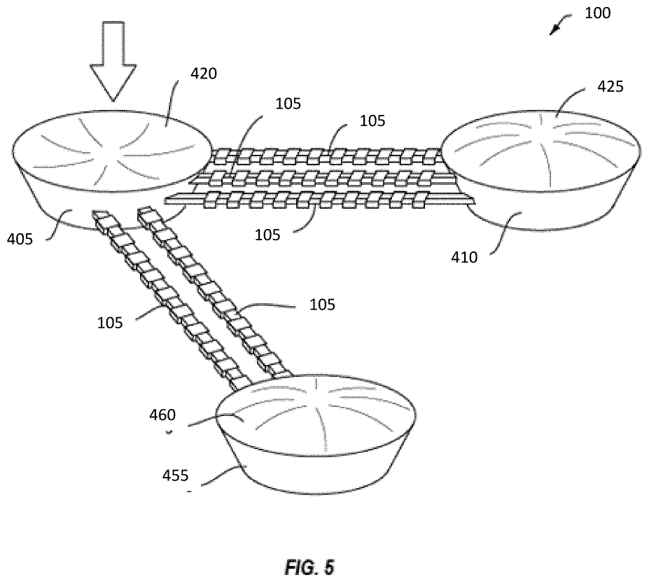

FIG. 5 illustrates the system 100 according to some embodiments. In such an embodiment, the system 100 may further include a third chamber 455. The third chamber 455 may be substantially similar to chambers 405, 410. Additionally, in some embodiments, the third chamber may include a piston 460. In such an embodiment, piston 460 may be substantially similar to pistons 420, 425.

In the illustrated embodiment, the third chamber 455 is in fluid communication with the first chamber 405 via one or more channels 105. However, in other embodiments, the third chamber 455 may be in fluid communication with the second chamber 410 (for example, via one or more channels 105).

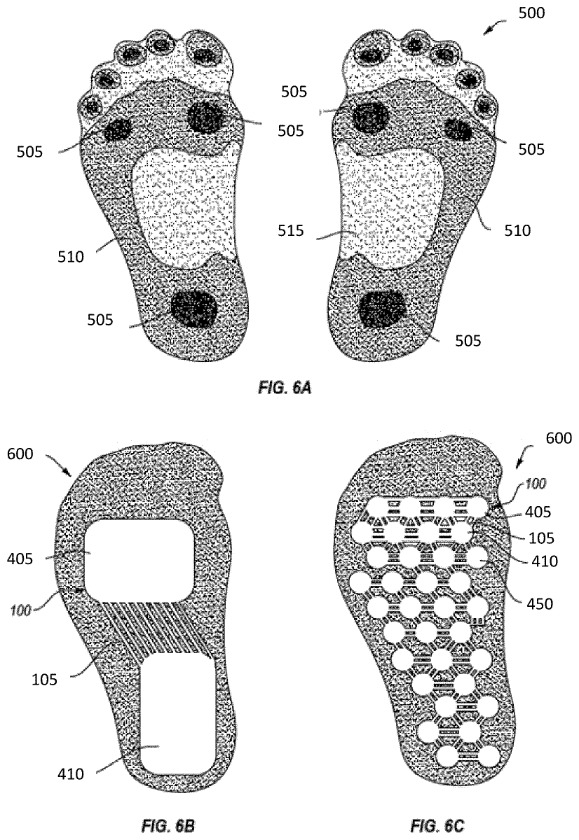

FIG. 6A illustrates feet 500 according to some embodiments. In some embodiments, feet 500 are human feet. As illustrated, feet 500 include one or more pressure areas, including but not limited to, high pressure areas 505, medium pressure areas 510, and low pressure areas 515. As an animal (for example, a human) walks, pressure may be transferred from the pressure areas 505, 510, 515 to the system 100. For example, such pressure may result in the forces F₁, F₂ on the system 100.

FIG. 6B illustrates the system 100 incorporated into an insole 600 according to some embodiments. In the illustrated embodiment, the system 100 includes chambers 405, 410 in fluid communication via one or more channels 105. As the animal (for example, human) walks, forces F₁, F₂ may be applied to the system 100 as discussed above to produce voltage e_{coil}.

FIG. 6C illustrates the system 100 incorporated into an insole 600 according to another embodiment. In the illustrated embodiment, the system 100 includes a plurality of chambers (for example, chambers 405, 410, 455) in fluid communication via one or more channels 105. As the animal (for example, human) walks, forces F₁, F₂ may be applied to the system 100 as discussed above to produce voltage e_{coil}.

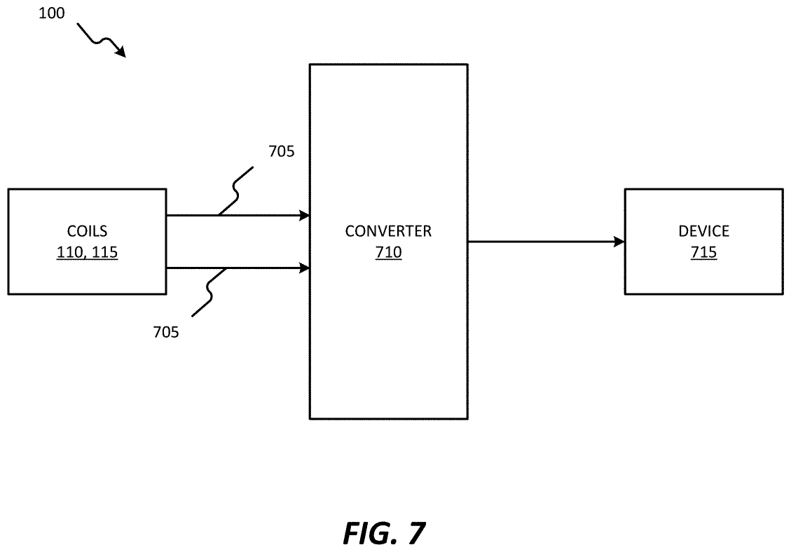

FIG. 7 is a block diagram of the system 100 according to some embodiments. In the illustrated embodiment, voltage e_{coil} included in coils 110, 115 is output via one or more leads 705 (also illustrated in FIGS. 1A & 1B). Voltage e_{coil} may be received by a converter 710 configured to convert voltage e_{coil} to an output voltage. In some embodiments, converter 710 is a rectifier or other AC-to-DC converter. In other embodiments, the converter 710 is a DC-DC converter. In yet other embodiments, converter 710 is an AC-to-AC converter. The output voltage may be received by a device 715. In some embodiments, the system 100 may further include an energy storage device (for example, a battery, a capacitor, etc.) for storing the output voltage.

Device 715 may be an electrical device configured to receive electric power. In some embodiments, device 715 is a heating device (for example, an electric heating device, such as but not limited to, a resistive heating device). In other embodiments, the device 715 may include one or more sensors, one or more lights (for example, light-emitting diodes (LEDS)),

Although some embodiments disclose system 100 being incorporated into a shoe, system 100 may be configured to be incorporated into various other devices and/or systems (for example, articles of clothing, vehicles, roads, sidewalks, etc.).

Thus, the application provides, among other things, an energy harvesting system. Various features and advantages of the application are set forth in the following claims.

What is claimed is:

1. An energy harvesting system comprising:
a channel;
a first coil having a clockwise rotation around the channel;
a second coil having a counter clockwise rotation around the channel; and
a magnetic train configured to move through the channel, the magnetic train including a plurality of oppositely-alternating magnets.

2. The system of claim 1, wherein the plurality of oppositely-alternating magnets include:
a first magnet having a first north polarity and a first south polarity, and
a second magnet having a second north polarity and a second south polarity, the second magnet positioned such that the second north polarity is proximate the first north polarity.

3. The system of claim 1, wherein the plurality of oppositely-alternating magnets include:
a first magnet having a first north polarity and a first south polarity, and
a second magnet having a second north polarity and a second south polarity, the second magnet positioned such that the second south polarity is proximate the first south polarity.

4. The system of claim 1, further comprising a plurality of microvalves configured to allow flow of a fluid through the channel.

5. The system of claim 4, wherein the flow of fluid moves the magnetic train through the channel.

6. The system of claim 1, wherein the first coil has a greater number of turns than the second coil.

7. The system of claim 1, the magnetic train moving through the first coil and the second coil produces energy.

8. The system of claim 1, wherein the channel has a first end connected to a first chamber and a second end connected to a second chamber.

9. The system of claim 7, wherein the first chamber and the second chamber are substantially filled with a fluid.

10. The system of claim 8, wherein the first chamber further includes a first piston and the second chamber further includes a second piston.

11. The system of claim 1, wherein the energy harvesting system is located within a shoe.

12. The system of claim 7, wherein energy produced by the system is used to heat an insole of the shoe.

13. A method for generating energy, the method comprising:
applying a force, via a piston, to a fluid to cause movement within a channel, the channel having a first coil having a clockwise rotation around the channel and a second coil having a counter clockwise rotation around the channel;
causing movement, via the fluid, of a magnet train situated within the channel, the magnet train including a plurality of oppositely-alternating magnets; and
generating, via the magnet train, a voltage in at least one selected from a group consisting of the first coil and the second coil.

14. The method of claim 13, wherein the plurality of oppositely-alternating magnets include:
a first magnet having a first north polarity and a first south polarity, and
a second magnet having a second north polarity and a second south polarity, the second magnet positioned such that the second north polarity is proximate the first north polarity.

15. The method of claim 13, wherein the plurality of oppositely-alternating magnets include:
a first magnet having a first north polarity and a first south polarity, and
a second magnet having a second north polarity and a second south polarity, the second magnet positioned such that the second south polarity is proximate the first south polarity.

16. The method of claim 13, wherein the fluid substantially fills a first chamber and a second chamber.

17. The method of claim 13, wherein the piston is a flexible membrane.

18. The method of claim 13, wherein the force is created by movement.

19. The method of claim 13, further comprising heating, via a heating device, an insole of a shoe, wherein the heating device receives the voltage.
